(19) United States
(12) Patent Application Publication
(10) Pub. No.: US 2008/0145041 A1
(43) Pub. Date: Jun. 19, 2008

(54) ANTI-SHAKE APPARATUS

(75) Inventor: Shigeo ENOMOTO, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/955,536

(22) Filed: Dec. 13, 2007

(30) Foreign Application Priority Data
Dec. 14, 2006 (JP) 2006-336547

(51) Int. Cl. G03B 17/00

(52) U.S. Cl. 396/53

(57) ABSTRACT

An anti-shake apparatus for image stabilization of a photographing apparatus comprises an imaging sensor, an acceleration sensor, and an inclination degree output unit. The imaging sensor has an imaging surface on which an optical image through a photographing optical system of the photographing apparatus is captured. The acceleration sensor detects a first gravitational acceleration component in a direction of a first detection axis and a second gravitational acceleration component in a direction of a second detection axis. The first detection axis and the second detection axis are perpendicular to an optical axis of the photographing optical system. The inclination degree output unit outputs information regarding an inclination angle caused by a roll of the photographing apparatus about the optical axis, based on the first gravitational acceleration component and the second gravitational acceleration component.

### BACKGROUND OF THE INVENTION

1. Field of the Invention

The present invention relates to an anti-shake apparatus (an image-blur correcting device) for an optical apparatus, and in particular to an anti-shake apparatus that restrains an effect caused by an error characteristic of a hand-shake extent detector such as a gyro sensor etc., when an inclination caused by the roll about the optical axis is compensated for.

2. Description of the Related Art

An image-blur correcting device (an anti-shake apparatus) for an optical apparatus is proposed. The image-blur correcting device reduces the hand-shake effect by moving a hand-shake correcting lens or an imaging sensor on a plane that is perpendicular to the optical axis, corresponding to the amount of hand-shake which occurs during imaging.

Japanese unexamined patent publication (KOKAI) No. 2005-351917 discloses an image-blur correcting device that features a hand-shake detector having a pitch gyro sensor, a rolling gyro sensor, and a yaw gyro sensor to detect the hand-shake extent, and has a movable unit that is rotatably and linearly moved in the x-y plane for an anti-shake operation based on the hand-shake extent.

However, in the case that the anti-shake operation (the compensation) of the hand-shake including the roll is performed by using the rolling gyro sensor, the image will be inclined due to the DC offset output from the rolling gyro sensor even if the inclination angle based on the roll is 0. Accordingly, the user will feel discomfort even if the degree of unnecessary inclination is very small (but not 0), especially while the user is observing the captured and inclined image on the display.

Furthermore, it is difficult to perfectly remove an error such as the DC offset output, etc.

### SUMMARY OF THE INVENTION

Therefore, an object of the present invention is to provide an anti-shake apparatus that restrains an output of the error component from the hand-shake extent detector for the roll.

According to the present invention, an anti-shake apparatus for image stabilization of a photographing apparatus comprises an imaging sensor, an acceleration sensor, and an inclination degree output unit. The imaging sensor has an imaging surface on which an optical image through a photographing optical system of the photographing apparatus is captured. The acceleration sensor detects a first gravitational acceleration component in a direction of a first detection axis and a second gravitational acceleration component in a direction of a second detection axis. The first detection axis and the second detection axis are perpendicular to an optical axis of the photographing optical system. The inclination degree output unit outputs information regarding an inclination angle caused by a roll of the photographing apparatus about the optical axis, based on the first gravitational acceleration component and the second gravitational acceleration component.

### BRIEF DESCRIPTION OF THE DRAWINGS

The objects and advantages of the present invention will be better understood from the following description, with reference to the accompanying drawings in which:

FIG. 1 is a perspective view of the photographing apparatus of the embodiment, viewed from the front of the photographing apparatus;

FIG. 2 is a construction diagram of the photographing apparatus;

FIG. 3 is a circuit construction diagram of the anti-shake unit of the photographing apparatus, when the acceleration sensor with two detection axes is used;

FIG. 4 is a front view of the photographing apparatus and a construction diagram of the acceleration sensor viewed from the front;

FIG. 5 is a front view of the photographing apparatus and a construction diagram of the acceleration sensor viewed from the front, when the photographing apparatus is rotated at an angle θ in a clockwise direction viewed from the front, from the first horizontal holding position;

FIG. 6 is a front view of the photographing apparatus and a construction diagram of the acceleration sensor viewed from the front, when the photographing apparatus is rotated at the angle (θ+90 degrees) in the clockwise direction viewed from the front, from the first horizontal holding position, (when the photographing apparatus is rotated at the angle θ in the clockwise direction viewed from the front side, from the first vertical holding position);

FIG. 7 is a front view of the photographing apparatus and a construction diagram of the acceleration sensor viewed from the front, when the photographing apparatus is rotated at the angle (θ+180 degrees) in the clockwise direction viewed from the front, from the first horizontal holding position, (when the photographing apparatus is rotated at the angle θ in the clockwise direction viewed from the front, from the second horizontal holding position);

FIG. 8 is a front view of the photographing apparatus and a construction diagram of the acceleration sensor viewed from the front, when the photographing apparatus is rotated at the angle (θ+270 degrees) in the clockwise direction viewed from the front, from the first horizontal holding position, (when the photographing apparatus is rotated at the angle θ in the clockwise direction viewed from the front, from the second vertical holding position;

FIG. 9 is a front view of the driving unit of the anti-shake unit;

FIG. 10 is a decomposed perspective view of the driving unit;

FIG. 11 is a perspective view of the driving unit; and

FIG. 12 is a circuit construction diagram of the anti-shake unit of the photographing apparatus, when the acceleration sensor with three detection axes is used.

### DESCRIPTION OF THE PREFERRED EMBODIMENTS

The present invention is described below with reference to the embodiment shown in the drawings. In the embodiment, the photographing apparatus 1 is a digital camera. A photographing lens (not depicted), which is included in lens barrel 2 of the photographing apparatus 1 has an optical axis O.

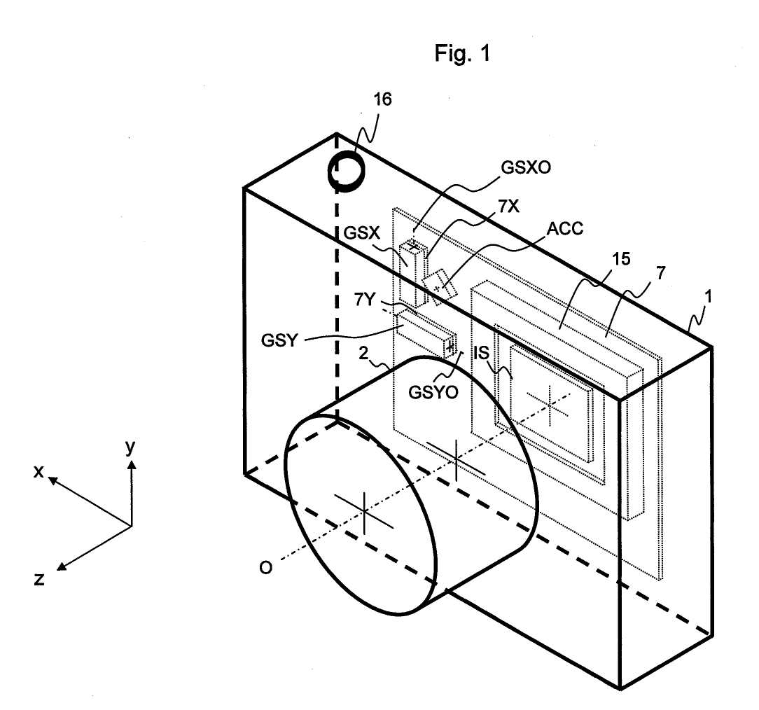

In order to explain the orientation in the embodiment, a first direction x, a second direction y, and a third direction z are defined (see FIG. 1). The first direction x is perpendicular to the optical axis O. The second direction y is perpendicular to the optical axis O and the first direction x. The third direction z is parallel to the optical axis O and perpendicular to both the first direction x and the second direction y.

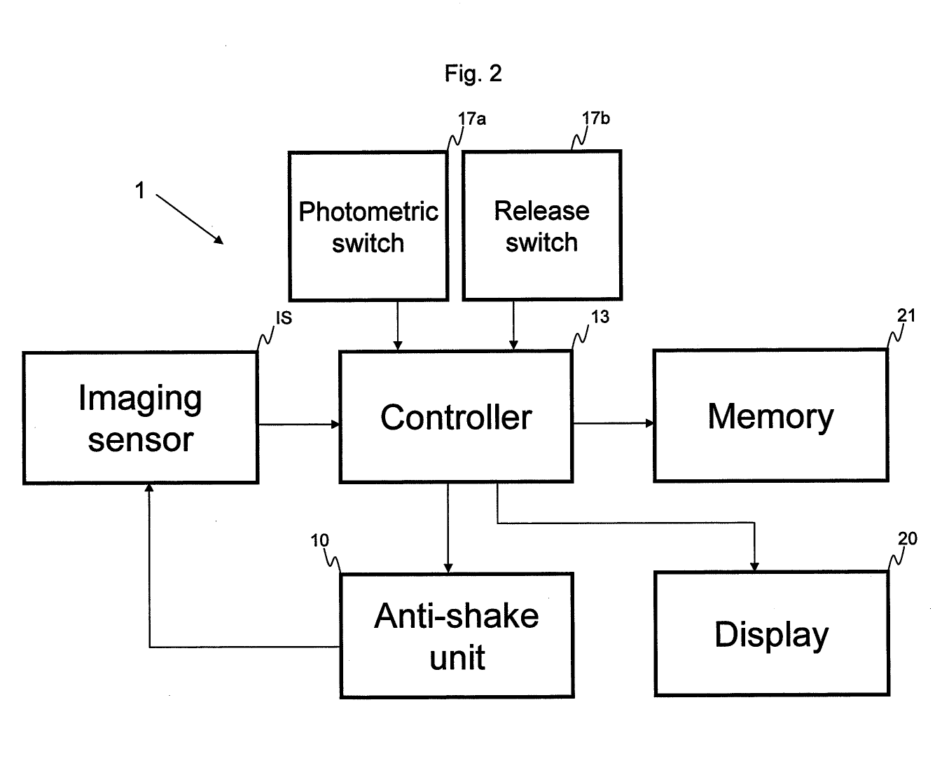

The photographing apparatus 1 has a lens barrel 2, and an imaging sensor IS (see FIG. 1). The photographing apparatus 1 also has an anti-shake unit 10, a controller 13, a display 20, and a memory 21 (see FIG. 2).

The photographic subject image is captured as an optical image through the photographing lens by the imaging sensor IS, and the captured image is displayed on the display 20. Specifically, an electric charge corresponding to the photographic subject image (an optical image) is accumulated through the photographing lens by the imaging sensor IS, which may be a CCD, or other sensor, and the accumulated electric charge is represented on the display 20 after A/D conversion and image processing have been completed by the controller 13. In addition, the image signal obtained by the imaging operation is stored in the memory 21.

When a release button 16 of the photographing apparatus 1 is partially depressed by the operator, a photometric switch 17a changes to the ON state so that the photometric operation, the AF sensing operation, and the focusing operation are performed.

When the release button 16 is fully depressed by the operator, a release switch 17b changes to the ON state so that the imaging operation is performed, and the captured image is stored in the memory 21.

The anti-shake unit 10 is an apparatus that reduces the effect of hand-shake, by linearly moving and rotating a movable unit 15a (a linear movement in the first direction x and in the second direction y, and a rotary movement in the x-y plane), and canceling the lag corresponding to hand-shake extent (the degree of hand-shake), of a photographic subject image on the imaging surface of the imaging sensor IS, thereby stabilizing the photographic subject image that reaches the imaging surface of the imaging sensor IS.

The anti-shake unit 10 has a hand-shake extent detector 11 that detects the extent (quantity) of hand-shake, and a driving unit 15 (an image-blur correcting device) that moves the movable unit 15a, including a rotation of the movable unit 15a in the x-y plane (the reference plane) perpendicular to the optical axis O, based on the hand-shake extent (quantity). The movement of the movable unit 15a is based on the hand-shake extent and is performed by the controller 13.

The hand-shake extent detector 11 detects the hand-shake extent by using an angular velocity sensor such as a gyro sensor, etc., and an acceleration sensor ACC. A pitch gyro sensor GSY, a yaw gyro sensor GSX, and the acceleration sensor ACC of the hand-shake extent detector 11 are attached to the main circuit board 7 of the photographing apparatus 1.

The controller 13 has a first vertical error amplifier 63A, a second vertical error amplifier 63B, a horizontal error amplifier 65, a first vertical PID (Proportional, Integral, and Derivative controls)-calculating circuit 66A, a second vertical PID-calculating circuit 66B, a horizontal PID-calculating circuit 68, a first vertical PWM driver 69A, a second vertical PWM driver 69B, and a horizontal PWM driver 71, in order to perform the anti-shake operation via PID control.

The controller 13 controls a movement of the movable unit 15a on the x-y plane, based on an output from the pitch gyro sensor GSY in response to an angular hand-shake extent due to the pitch, an output from the yaw gyro sensor GSX in response to an angular hand-shake extent due to the yaw, and an output (an inclination angle) from the acceleration sensor ACC in response to an angular hand-shake extent due to the roll, in order to perform the anti-shake operation.

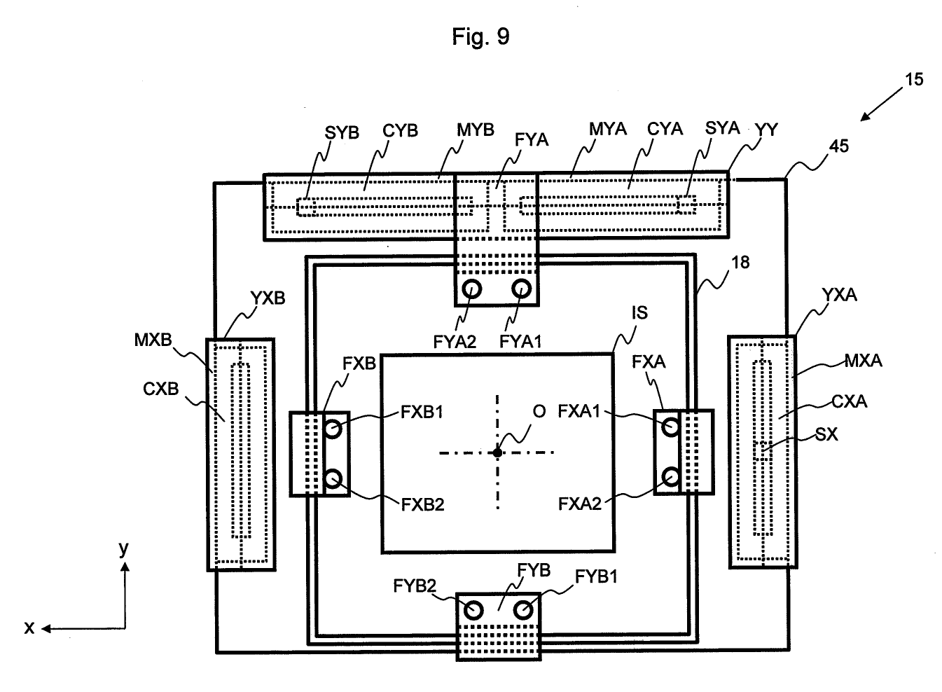

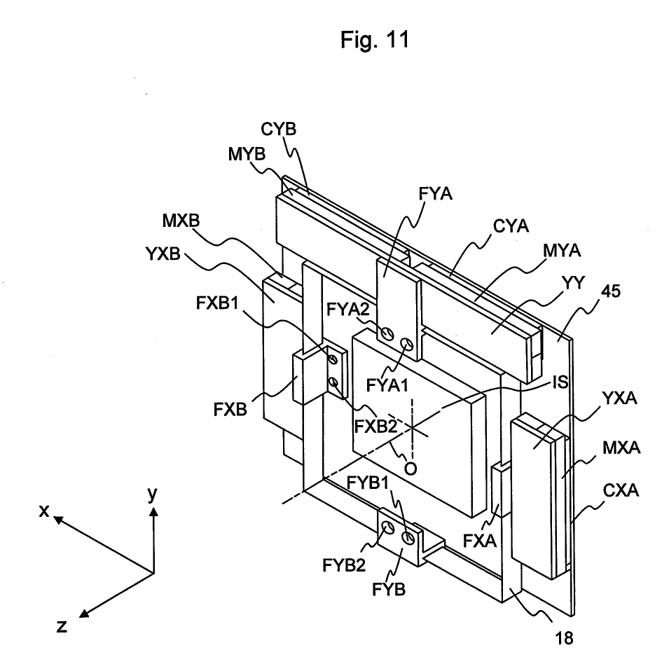

The driving unit 15 has movable unit 15a and fixed unit 15b (see FIGS. 1, 9 and 11). The movable unit 15a is linearly movable and rotatable with regard to the fixed unit 15b that is fixed to the photographing apparatus 1, in the x-y plane.

The movable unit 15a has a circuit board 45 to which the imaging sensor IS is attached, a first horizontal driving coil CXA, a second horizontal driving coil CXB, a first vertical driving coil CYA, a second vertical driving coil CYB, a first vertical hall sensor SYA, a second vertical hall sensor SYB, and a horizontal hall sensor SX.

The fixed unit 15b has a frame 18, a first horizontal frame connecting unit FXA, a second horizontal frame connecting unit FXB, a first vertical frame fixing unit FYA, a second vertical frame fixing unit FYB, a first horizontal driving and position-detecting yoke YXA, a second horizontal driving and position-detecting yoke YXB, a vertical driving and position-detecting yoke YY, a first horizontal driving and position-detecting magnet MXA, a second horizontal driving and position-detecting magnet MXB, a first vertical driving and position-detecting magnet MYA, and a second vertical driving and position-detecting magnet MYB.

The back of the fixed unit 15b of the driving unit 15 is attached to the main circuit board 7, and the front of the fixed unit 15b is attached to the lens barrel 2.

First, the details of the hand-shake extent detector 11 will be explained (see FIGS. 1 to 8). The hand-shake extent detector 11 has the pitch gyro sensor GSY, the yaw gyro sensor GSX, a pitch A/D converter ADY, a yaw A/D converter ADX, a pitch high-pass filter circuit HPY, a yaw high-pass filter circuit HPX, a pitch integrated circuit 60Y, a yaw integrated circuit 60X, an acceleration sensor ACC (with a first detection axis AX1 and a second detection axis AX2), a first A/D converter AD1, a second A/D converter AD2, and a differential calculation unit 61 as an inclination degree (quantity) output unit.

The pitch gyro sensor GSY is arranged so that an angular velocity detection axis GSYO of the pitch gyro sensor GSY is parallel to the first direction x, and detects the angular velocity of a rotary motion (the pitch) of the photographing apparatus 1 about the axis of the first direction x.

The yaw gyro sensor GSX is arranged so that the angular velocity detection axis GSXO of the yaw gyro sensor GSX is parallel to the second direction y, and detects the angular velocity of a rotary motion (the yaw) of the photographing apparatus 1 about the axis of the second direction y.

The pitch gyro sensor GSY and the yaw gyro sensor GSX are respectively mounted on a pitch gyro sensor base circuit board 7Y and a yaw gyro sensor base circuit board 7X. The pitch gyro sensor base circuit board 7Y and the yaw gyro sensor base circuit board 7X are mounted on the main circuit board 7.

The pitch high-pass filter circuit HPY removes a low-frequency component of a signal representing the angular velocity from the pitch gyro sensor GSY (i.e., it removes the DC offset when a waveform is off-center in the up and down direction), after the A/D conversion by the pitch A/D converter ADY.

The pitch integrated circuit 60Y integrates the high-frequency signal which has had its low-frequency component removed by the pitch high-pass filter circuit HPY.

Based on the integrated signal, the pitch integrated circuit 60Y generates a pitch angular signal Pyh as an output value corresponding to the angular hand-shake extent (quantity) due to the pitch.

The yaw high-pass filter circuit HPX removes the low-frequency component of a signal representing the angular velocity from the yaw gyro sensor GSX (i.e., it removes the DC offset when a waveform is off-center in the up and down direction), after the A/D conversion by the yawing A/D converter ADX.

The yaw integrated circuit 60X integrates the high-frequency signal that which had its low-frequency component removed by the yaw high-pass filter circuit HPX.

Based on the integrated signal, the yaw integrated circuit 60X generates a yaw angular signal Pxh as an output value corresponding to the angular hand-shake extent (quantity) due to the yaw.

The acceleration sensor ACC detects a gravitational acceleration component in a direction of the detection axis. Specifically, the acceleration sensor ACC detects a first gravity acceleration GR1 (the first gravitational acceleration component) in the direction of the first detection axis AX1 and a second gravity acceleration GR2 (the second gravitational acceleration component) in the direction of the second detection axis AX2. The acceleration sensor ACC is attached to the main circuit board 7 (see FIG. 1).

The first detection axis AX1 and the second detection axis AX2 are arranged so that the first detection axis AX1 is perpendicular to the second detection axis AX2 and the third direction z, and the second detection axis AX2 is perpendicular to the third direction z.

The directions of the first and second detection axes AX1 and AX2 change according to the holding position of the photographing apparatus 1.

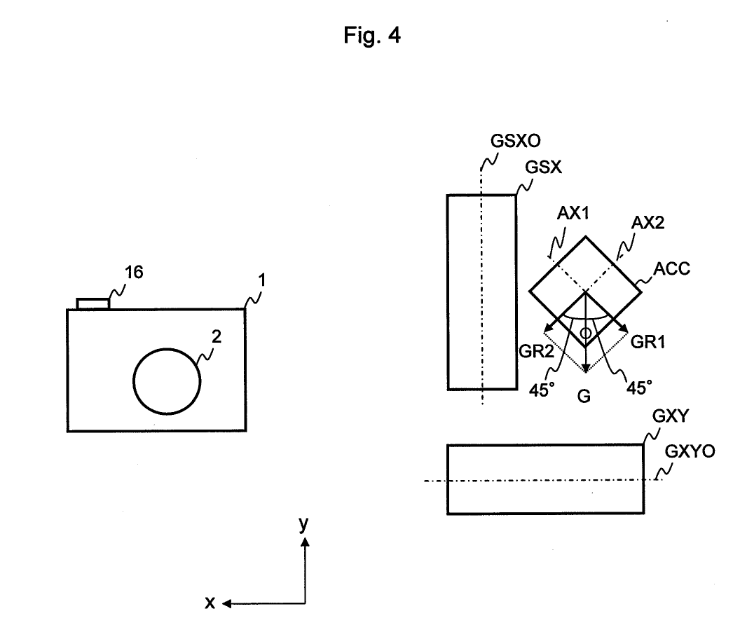

It is desirable that the first detection axis AX1 crosses the first direction x and the second direction y at an angle of 45 degrees, in other words, such that the first detection axis AX1 crosses the direction of gravitational force at an angle of 45 degrees (see FIG. 4), under one of a first condition C1 and a second condition C2. The first condition C1 is that the photographing apparatus 1 is held horizontally (held level) such that the imaging surface of the imaging sensor IS is perpendicular to the horizontal surface and one pair of sides composing the outline of the imaging surface of the imaging sensor IS is parallel to the horizontal direction before the movable unit 15a is not controlled to move. The second condition C2 is that the photographing apparatus 1 is held vertically (held level) such that the imaging surface of the imaging sensor IS is perpendicular to the horizontal surface and the other pair of sides that compose the outline of the imaging surface of the imaging sensor IS is parallel to the vertical direction before the movable unit 15a is not controlled to move.

Similarly, it is desirable that the second detection axis AX2 crosses the first direction x and the second direction y at an angle of 45 degrees in the situation where the photographing apparatus 1 is held horizontally or vertically, in other words, when the second detection axis AX2 crosses the direction of gravitational force at an angle of 45 degrees.

A signal representing acceleration in the direction of the first detection axis AX1 detected by the acceleration sensor ACC, which is the first gravity acceleration GR1, is converted from an analog signal to a digital signal by the first A/D converter AD1.

A signal representing acceleration in the direction of the second direction axis AX2 detected by the acceleration sensor ACC, which is the second gravity acceleration GR2, is converted from an analog signal to a digital signal by the second A/D converter AD2.

The differential calculation unit 61 calculates the absolute value of a differential between the absolute value of the first gravity acceleration GR1 after the A/D conversion by the first A/D converter AD1, and the absolute value of the second gravity acceleration GR2 after the A/D conversion by the second A/D converter A/D 2, expressed as |GR1|−|GR2∥.

Based on the calculation, the differential calculation unit 61 generates (outputs) a roll angular signal Prh as an output value corresponding to an inclination angle (the angular hand-shake extent (quantity)) due to a rotary motion (the roll) of the photographing apparatus 1 about the axis of the third direction z.

In the embodiment, the integrating calculation is not used to calculate the roll angular signal Prh, because it is not necessary. Therefore, the roll angular signal Prh is not affected by the DC offset output (an error component) so that detection of the hand-shake extent (quantity) by the roll can be accurately performed.

In the case that the DC offset output affects the integrating calculation, the roll angular signal Prh shows an indefinite value even if there is no roll component in the hand-shake, i.e., even if the hand-shake component based on the roll about the axis of the third direction z is 0 (even if the inclination angle based on the rotary motion (the roll) is 0). Accordingly, the movable unit 15a is rotated (inclined) based on the anti-shake operation determined for the roll angular signal Prh having an indefinite value due to the DC offset output at the moment before the anti-shake operation.

This inclination of the movable unit 15a produces an undesirable inclination of the imaging sensor IS. When the imaging sensor IS is inclined, the captured image will also be inclined. Accordingly, the user will feel discomfort even if the degree of unnecessary inclination is very small (but not 0), especially while the user is observing the captured and inclined image on the display 20.

However, in the embodiment, the roll angular signal Prh is not affected by the DC offset output so that the user does not feel discomfort based on unnecessary inclination of the imaging sensor IS because there is no unnecessary inclination.

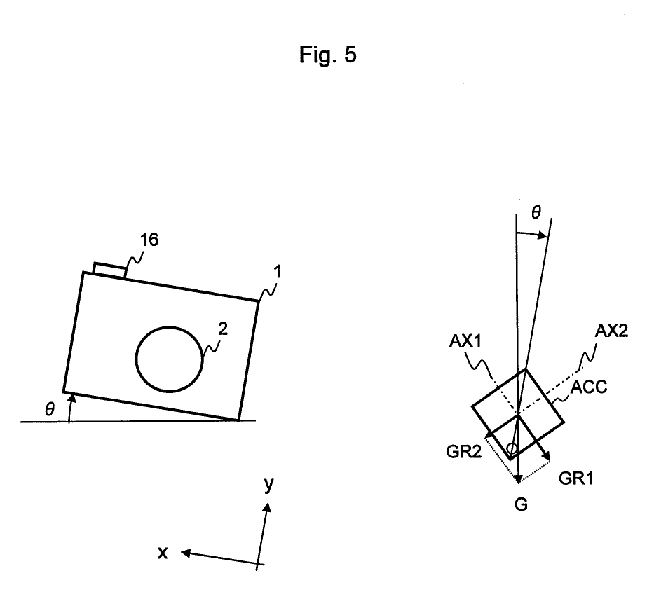

For example, when the photographing apparatus 1 is rotated at an angle θ in the clockwise direction as viewed from the front (see FIG. 5), from a first horizontal holding position where the photographing apparatus 1 is held horizontally and the upper surface of the photographing apparatus 1 faces upward (see FIG. 4), the differential between the first gravity acceleration GR1 and the second gravity acceleration GR2 is given GR1−GR2=G×{sin(π÷4+θ)−sin(π÷4−θ)}=2G×cos(π÷4)×sin θ. The differential between the first gravity acceleration GR1 and the second gravity acceleration GR2 is a function of θ.

Particularly, when the inclination angle is within ±0.2rad (≈±11 degrees), the differential between the first gravity acceleration GR1 and the second gravity acceleration GR2 is approximately proportional to the inclination angle θ.

Therefore, the inclination angle (the angular component of hand-shake based on the rotary motion about the axis of the third direction z) can be calculated on the basis of the differential between the absolute value of the first gravity acceleration GR1 and the absolute value of the second gravity acceleration GR2, given by |GR1|−|GR2|.

In order to match the sign (i.e., direction) of the first and second gravity accelerations GR1 and GR2 caused by the change of the holding position of the photographing apparatus 1, the absolute value is used in the above calculation. For example, when the photographing apparatus 1 is in the first horizontal holding position (see FIG. 4), the values of the first and second gravity accelerations GR1 and GR2 are both positive and the same value.

When the photographing apparatus 1 is rotated (inclined) at the angle θ in the clockwise direction as viewed from the front (see FIG. 5), from the first horizontal holding position, the values of the first and second gravity accelerations GR1 and GR2 are both positive and the absolute value of the first gravity acceleration GR1 is greater than the absolute value of the second gravity acceleration GR2.

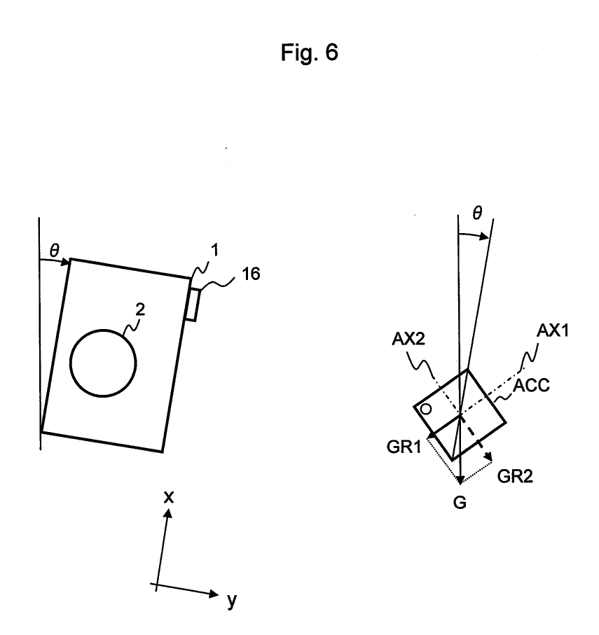

When the photographing apparatus 1 is rotated (inclined) at the angle (θ+90 degrees) in the clockwise direction as viewed from the front, from the first horizontal holding position, in other words, when the photographing apparatus 1 is rotated (inclined) at the angle θ in the clockwise direction as viewed from the front, from a first vertical holding position where the photographing apparatus 1 is held vertically and one of the side surfaces of the photographing apparatus 1 faces upward, the value of the first gravity acceleration GR1 is positive (solid arrow line), the second gravity acceleration GR2 is negative (broken arrow line), and the absolute value of the second gravity acceleration GR2 is greater than the absolute value of the first gravity acceleration GR1 (see FIG. 6).

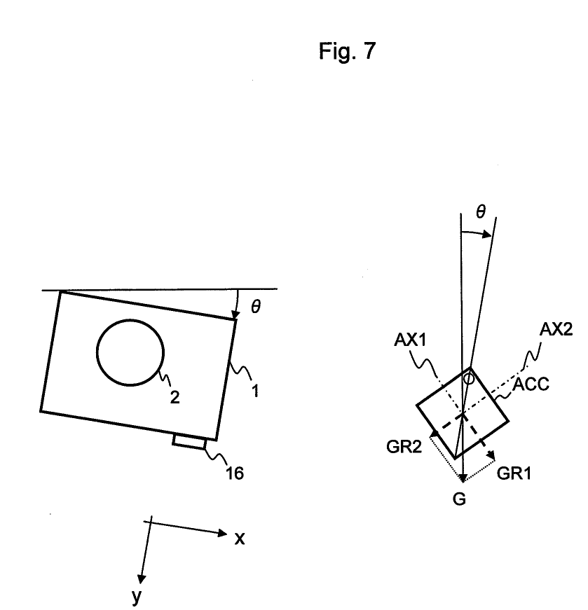

When the photographing apparatus 1 is rotated (inclined) at the angle (θ+180 degrees) in the clockwise direction as viewed from the front, from the first horizontal holding position, in other words, when the photographing apparatus 1 is rotated (inclined) at the angle θ in the clockwise direction as viewed from the front, from a second horizontal holding position where the photographing apparatus 1 is held horizontally and the lower surface of the photographing apparatus 1 faces upward, the values of the first and second gravity accelerations GR1 and GR2 are both negative, and the absolute value of the first gravity acceleration GR1 is greater than the absolute value of the second gravity acceleration GR2 (see FIG. 7).

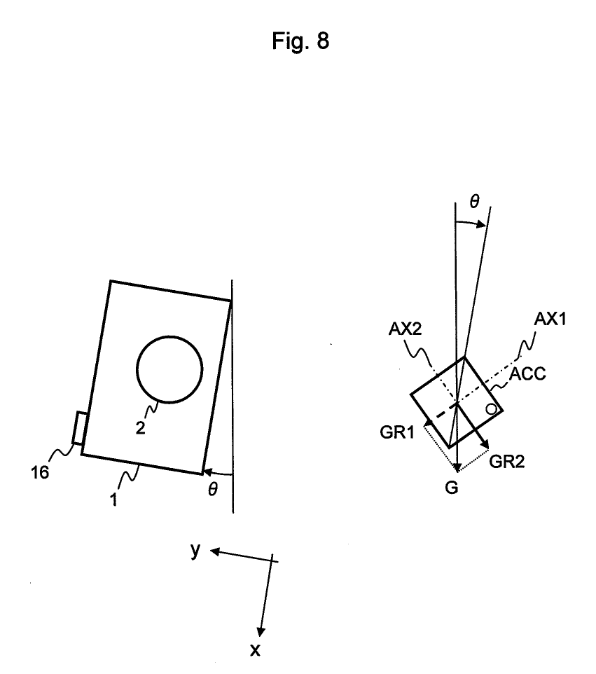

When the photographing apparatus 1 is rotated (inclined) at the angle (θ+270 degrees) in the clockwise direction as viewed from the front, from the first horizontal holding position, in other words, when the photographing apparatus 1 is rotated (inclined) at the angle θ in the clockwise direction as viewed from the front, from a second vertical holding position where the photographing apparatus 1 is held vertically and the other side surface of the photographing apparatus 1 faces upward, the value of the first gravity acceleration GR1 is negative (broken arrow line), the second gravity acceleration GR2 is positive (solid arrow line), and the absolute value of the second gravity acceleration GR2 is greater than the absolute value of the first gravity acceleration GR1 (see FIG. 8).

The differential calculation unit 61 calculates the absolute value of the differential between the absolute value of the first acceleration GR1 and the absolute value of the second acceleration GR2, given as λGR1|−|GR2∥, and calculates the sum of the absolute value of the first gravity acceleration GR1 and the absolute value of the second gravity acceleration GR2, given as |GR1|+|GR2|.

When the absolute value of the differential between the absolute value of the first acceleration GR1 and the absolute value of the second acceleration GR2 (given as |GR1|−|GR2∥) is greater than a first value, or when the sum of the absolute value of the first gravity acceleration GR1 and the absolute value of the second gravity acceleration GR2 (given as |GR1|+|GR2|) is smaller than a second value, the differential calculation unit 61 does not output the roll angular signal Prh.

The case in which the absolute value of the differential between the absolute value of the first acceleration GR1 and the absolute value of the second acceleration GR2, given as ∥GR1|−|GR2∥, is greater than the first value, is assumed to be a case in which it is not necessary to consider the inclination caused by the roll of the photographing apparatus 1 in the anti-shake operation, because the degree of the inclination and the hand-shake extent caused by the roll of the photographing apparatus 1 can not be calculated accurately. For example, when the imaging operation is performed under the condition where the photographing apparatus 1 is deliberately inclined, it is not necessary to consider the inclination caused by the roll of the photographing apparatus 1 in the anti-shake operation.

The case in which the sum of the absolute value of the first gravity acceleration GR1 and the absolute value of the second gravity acceleration GR2, given as |GR1|+|GR2|, is smaller than the second value, is assumed to be a case in which the angle at which the optical axis of the photographing apparatus 1 is crossing the horizontal surface at close to 90 degrees; in other words, the front surface of the photographing apparatus 1 largely faces upward or downward, because the degree of the inclination and the hand-shake extent caused by the roll of the photographing apparatus 1 can not be calculated accurately.

The pitch angular signal Pyh is used for movement control of the movable unit 15a, based on the hand-shake extent, by the controller 13, as a signal that specifies the hand-shake extent based on the rotary motion (the pitch) about the axis of the first direction x.

The roll angular signal Prh is used for movement control of the movable unit 15a, based on the hand-shake extent, by the controller 13, as a signal that specifies the hand-shake extent based on the rotary motion (the roll) about the axis of the third direction z.

The yaw angular signal Pxh is used for movement control of the movable unit 15a, based on the hand-shake extent, by the controller 13, as a signal that specifies the hand-shake extent based on the rotary motion (the yaw) about the axis of the second direction y.

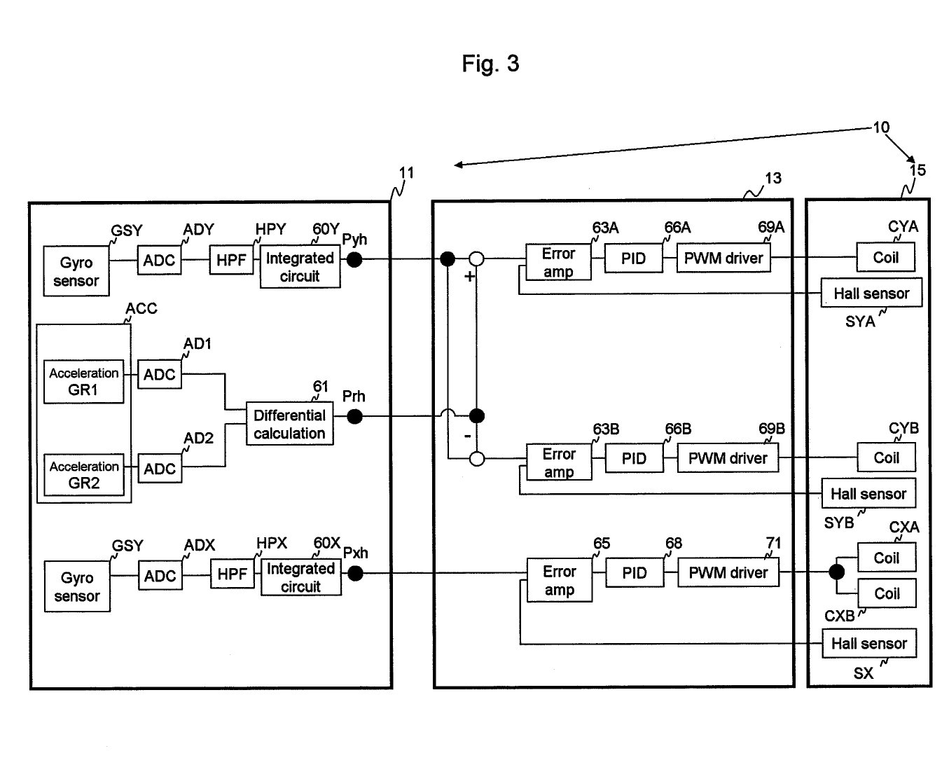

Next, the detail of the controller 13 is explained (see FIG. 3). In the case where a CPU is used as the controller 13, the operation of the integrated circuit, the error amplifier, the PID-calculating circuit, and the PWM driver can be performed by using software.

The pitch angular signal Pyh and the roll angular signal Prh are input to the first vertical error amplifier 63A. The pitch angular signal Pyh and the roll angular signal Prh are input to the second vertical error amplifier 63B.

The total value of the pitch angular signal Pyh and the roll angular signal Prh, and an output value from the first vertical hall sensor SYA, are input to the first vertical error amplifier 63A.

The differential value between the pitch angular signal Pyh and the roll angular signal Prh, and an output value from the second vertical hall sensor SYB are input to the second vertical error amplifier 63B.

The yaw angular signal Pxh and an output value from the horizontal hall sensor SX are input to the horizontal error amplifier 65.

The first vertical error amplifier 63A compares the total value of the pitch angular signal Pyh and the roll angular signal Prh with the output value of the first vertical hall sensor SYA. Specifically, the first vertical error amplifier 63A calculates a differential value between this total value of the angular signals Pyh and Prh and this output value of the hall sensor SYA.

The second vertical error amplifier 63B compares the differential value between the pitch angular signal Pyh and the roll angular signal Prh with the output value of the second vertical hall sensor SYB. Specifically, the second vertical error amplifier 63B calculates a differential value between this differential value of the angular signals Pyh and Prh and this output value of the hall sensor SYB.

The horizontal error amplifier 65 calculates the differential value between the yaw angular signal Pxh and the output value of the horizontal hall sensor SX.

The first vertical PID-calculating circuit 66A performs a PID calculation based on the output value of the first vertical error amplifier 63A.

The second vertical PID-calculating circuit 66B performs a PID calculation based on the output value of the second vertical error amplifier 63B.

Specifically, the first vertical PID-calculating circuit 66A computes a voltage value to supply to the first vertical driving coil CYA, such as the duty ratio of a PWM pulse that effectively reduces the differential value between the total integrated value of the angular signals Pyh and Prh and the output value of the hall sensor SYA (effectively reducing the output value of the first vertical error amplifier 63A).

The second vertical PID-calculating circuit 66B computes a voltage value to supply to the second vertical driving coil CYB, such as the duty ratio of a PWM pulse that effectively reduces the differential value between the differential value of the angular signals Pyh and Prh and the output value of the hall sensor SYB (effectively reducing the output value of the second vertical error amplifier 63B).

The first vertical PWM driver 69A applies the PWM pulse based on the result of the calculation of the first vertical PID-calculating circuit 66A, to the first vertical driving coil CYA.

The second vertical PWM driver 69B applies the PWM pulse based on the result of the calculation of the second vertical PID-calculating circuit 66B, to the second vertical driving coil CYB.

At the first and second vertical driving coils CYA and CYB, driving forces resulting from the application of the PWM pulse occur in the second direction y, so that the movable unit 15a can be moved in the second direction y in the x-y plane based on the driving forces in the second direction y.

When the driving force that occurs in the first vertical driving coil CYA is different from the driving force that occurs in the second vertical driving coil CYB, the movable unit 15a is rotated in the x-y plane based on the differential between the driving forces in the second direction y.

When the absolute value of the differential between the absolute value of the first acceleration GR1 and the absolute value of the second acceleration GR2, given by ∥GR1|−|GR2∥, is greater than the first value, or when the sum of the absolute value of the first gravity acceleration GR1 and the absolute value of the second gravity acceleration GR2, given by |GR1|+|GR2|, is smaller than the second value, the differential calculation unit 61 does not output the roll angular signal Prh.

Therefore, the roll angular signal Prh becomes 0 output so that the driving force that occurs in the first vertical driving coil CYA is the same as the driving force that occurs in the second vertical driving coil CYB. In this case, movable unit 15a is moved in the second direction y, but the movable unit 15a is not rotated in the x-y plane.

The horizontal PID-calculating circuit 68 performs a PID calculation based on the output value of the horizontal error amplifier 65.

Specifically, the horizontal PID-calculating circuit 68 computes a voltage value to supply to the first and second horizontal driving coils CXA and CXB, such as a duty ratio of a PWM pulse that effectively reduces the differential value between the yaw angular signal Pxh and the output value of the horizontal hall sensor SX (effectively reducing the output value of the horizontal error amplifier 65).

The horizontal PWM driver 71 applies the PWM pulse based on the effect of the calculation of the horizontal PID-calculating circuit 68, to the first and second horizontal driving coils CXA and CXB.

At the first and second horizontal driving coils CXA and CXB, a driving force resulting from the application of the PWM pulse occurs in the first direction x, so that the movable unit 15a can be moved in the first direction x in the x-y plane based on the driving force in the first direction x.

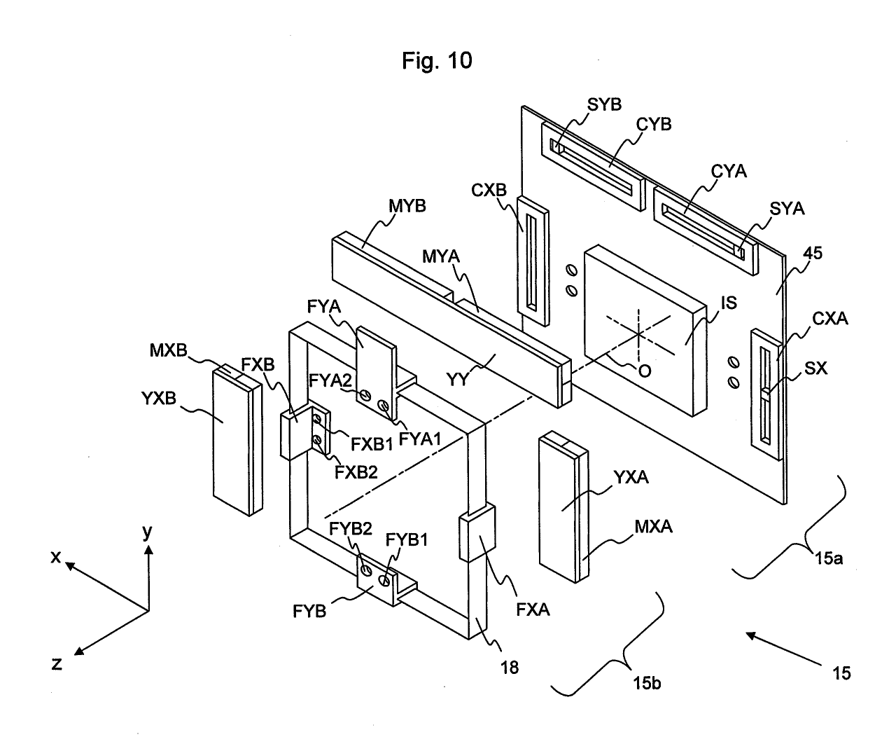

Next, the details of the driving unit 15 will be explained (see FIGS. 3, and 9 to 11). The first horizontal driving coil CXA, the second horizontal driving coil CXB, the first vertical driving coil CYA, the second vertical driving coil CYB, the first horizontal frame connecting unit FXA, the second horizontal frame connecting unit FXB, the first vertical hall sensor SYA, the second vertical hall sensor SYB, and the horizontal hall sensor SX are attached to the circuit board 45.

The frame 18 is a rectangular frame that is composed of four thin rectangular strips that are perpendicular to the x-y plane, forming a rectangular shape whose inside is hollow when viewed from the third direction z, and which are non-magnetic elastic members. The strips have a predetermined width, oriented in a direction perpendicular to the x-y plane.

The two strips of the frame 18 that face each other in the first direction x are attached to (connected with) the circuit board 45 through the first and second horizontal frame connecting units FXA and FXB. The other two strips of the frame 18 that face each other in the second direction y are attached to (fixed to) the fixed unit 15b (the lens barrel 2) with the first and second vertical frame fixing units FYA and FYB. The frame 18 surrounds the imaging sensor IS, or the imaging sensor IS is located in the inner side of the frame 18.

The first horizontal frame connecting unit FXA is attached to the circuit board 45 with tightening screws through the first horizontal frame connecting holes FXA1 and FXA2.

The second horizontal frame connecting unit FXB is attached to the circuit board 45 with tightening screws through the second horizontal frame connecting holes FXB1 and FXB2.

The first vertical frame fixing unit FYA is attached to the lens barrel 2 with tightening screws through the first vertical frame fixing holes FYA1 and FYA2.

The second vertical frame fixing unit FYB is attached to the lens barrel 2 with tightening screws through the second vertical frame fixing holes FYB1 and FYB2.

The frame 18 has a rectangular shape that has two horizontal sides parallel to the first direction x and two vertical sides parallel to the second direction y, when viewed from the third direction z. However, this rectangular shape is transformed elastically in the x-y plane, corresponding to the movement of the circuit board 45 in the x-y plane. Accordingly, the circuit board 45 is movably and rotatably supported in the x-y plane by the fixed unit 15b and lens barrel 2 through the frame 18.

The first horizontal frame connecting unit FXA is attached to the center area of one of the two vertical sides (strips), parallel to the second direction y, of the frame 18.

The second horizontal frame connecting unit FXB is attached to the center area of the other of the two vertical sides (strips), parallel to the second direction y, of the frame 18.

The imaging sensor IS is arranged between the first and second horizontal frame connecting units FXA and FXB in the first direction x, when viewed from the third direction z.

The first vertical frame fixing unit FYA is attached to the center area of one of the two horizontal sides (strips), parallel to the first direction x, of the frame 18.

The second vertical frame fixing unit FYB is attached to the center area of the other of the two horizontal sides (strips), parallel to the first direction x, of the frame 18.

The imaging sensor IS is arranged between the first and second vertical frame fixing units FYA and FYB in the second direction y, when viewed from the third direction z.

The frame 18 is made from non-magnetic metal or resin, and at least parts of the first and second horizontal frame connecting units FXA and FXB and the first and second vertical frame fixing units FYA and FYB are made from resin.

The frame 18, the first horizontal frame connecting unit FXA, the second horizontal frame connecting unit FXB, the first vertical frame fixing unit FYA, and the second vertical frame fixing unit FYB are formed by insert molding.

In the case that the frame 18 is made from resin, the first horizontal frame connecting unit FXA, the second horizontal frame connecting unit FXB, the first vertical frame fixing unit FYA, and the second vertical frame fixing unit FYB may be formed an united molding.

The first and second horizontal driving and position-detecting yokes YXA and YXB and the vertical driving and position-detecting yoke YY are board-shaped metallic magnetic members.

The first horizontal driving and position-detecting yoke YXA is arranged perpendicularly to the third direction z, and attached (glued) to the lens barrel 2 on the right side when viewed from the third direction z and the lens barrel 2 side.

The second horizontal driving and position-detecting yoke YXB is arranged perpendicularly to the third direction z, and attached (glued) to the lens barrel 2 on the left side when viewed from the third direction z and the lens barrel 2 side.

The vertical driving and position-detecting yoke YY is arranged perpendicularly to the third direction z, and attached (glued) to the first vertical frame fixing unit FYA on the top side when viewed from the third direction z and the lens barrel 2 side.

The imaging sensor IS is arranged between the first and second horizontal driving and position-detecting yokes YXA and YXB in the first direction x, when viewed from the third direction z.

The first horizontal driving and position-detecting magnet MXA is attached to the first horizontal driving and position-detecting yoke YXA. The second horizontal driving and position-detecting magnet MXB is attached to the second horizontal driving and position-detecting yoke YXB. The first and second vertical driving and position-detecting magnets MYA and MYB are attached to the vertical driving and position-detecting yoke YY.

In an initial state before the movable unit 15a starts to move under the condition in which it is not affected by gravity, namely when the imaging surface of the imaging sensor IS lies parallel to the horizontal plane (i.e., faces upwards or downwards), it is desirable that: 1.) the circuit board 45 be arranged such that the optical axis O passes through the center of the effective imaging field of the imaging sensor IS; 2.) two sides of the rectangle of the effective imaging field of the imaging sensor IS be parallel to the first direction x; 3.) the other two sides of the rectangle of the effective imaging field of the imaging sensor IS be parallel to the second direction y, and 4.) that the frame 18 not be transformed elastically and form a rectangular shape.

The imaging sensor IS is arranged at the side of the circuit board 45 that faces the lens barrel 2.

The first horizontal driving coil CXA and the horizontal hall sensor SX face the first horizontal driving and position-detecting magnet MXA in the third direction z. The second horizontal driving coil CXB faces the second horizontal driving and position-detecting magnet MXB in the third direction z.

The first vertical driving coil CYA and the first vertical hall sensor SYA face the first vertical driving and position-detecting magnet MYA in the third direction z. The second vertical driving coil CYB and the second vertical hall sensor SYB face the second vertical driving and position-detecting magnet MYB in the third direction z.

The first and second horizontal driving and position-detecting magnets MXA and MXB are magnetized in the third direction z (i.e., the thickness direction), the N pole and S pole of the first horizontal driving and position-detecting magnet MXA are arranged in the first direction x, and the N pole and S pole of the second horizontal driving and position-detecting magnet MXB are arranged in the first direction x.

The length of the first horizontal driving and position-detecting magnet MXA in the second direction y, is longer in comparison with the effective length of the first horizontal driving coil CXA in the second direction y, so that the first horizontal driving coil CXA and the horizontal driving sensor SX remain in a constant magnetic field throughout the movable unit's 15a full range of motion in the second direction y.

The length of the second horizontal driving and position-detecting magnet MXB in the second direction y, is longer in comparison with the effective length of the second horizontal driving coil CXB in the second direction y, so that the second horizontal driving coil CXB remains in a constant magnetic field throughout the movable unit's 15a full range of motion in the second direction y.

The first and second vertical driving and position-detecting magnets MYA and MYB are magnetized in the third direction z (in the thickness direction), the N pole and S pole of the first vertical driving and position-detecting magnet MYA are arranged in the second direction y, and the N pole and S pole of the second vertical driving and position-detecting magnet MYB are arranged in the second direction y.

The length of the first vertical driving and position-detecting magnet MYA in the first direction x, is longer in comparison with the effective length of the first vertical driving coil CYA in the first direction x, so that the first vertical driving coil CYA and the first vertical hall sensor SYA remain in a constant magnetic field throughout the movable unit's 15a full range of motion in the first direction x.

The length of the second vertical driving and position-detecting magnet MYB in the first direction x, is longer in comparison with the effective length of the second vertical driving coil CYB in the first direction x, so that the second vertical driving coil CYB and the second vertical hall sensor SYB remain in a constant magnetic field throughout the movable unit's 15a full range of motion in the first direction x.

The coil pattern of the first horizontal driving coil CXA has a line segment which is parallel to the second direction y, so that the movable unit 15a, which includes the first horizontal driving coil CXA, moves in the first direction x when a horizontal electro-magnetic force is applied.

The coil pattern of the second horizontal driving coil CXB has a line segment which is parallel to the second direction y, so that the movable unit 15a, which includes the second horizontal driving coil CXB, moves in the first direction x when the horizontal electro-magnetic force is applied.

The horizontal electro-magnetic force occurs on the basis of the current that flows through the first horizontal driving coil CXA and the magnetic field of the first horizontal driving and position-detecting magnet MXA and on the basis of the current that flows through the second horizontal driving coil CXB and the magnetic field of the second horizontal driving and position-detecting magnet MXB.

The coil pattern of the first vertical driving coil CYA has a line segment which is parallel to the first direction x, so that the movable unit 15a, which includes the first vertical driving coil CYA, moves in the second direction y when a first vertical electro-magnetic force is applied.

The first vertical electro-magnetic force occurs on the basis of the current that flows through the first vertical driving coil CYA and the magnetic field of the first vertical driving and position-detecting magnet MYA.

The coil pattern of the second vertical driving coil CYB has a line segment which is parallel to the first direction x, so that the movable unit 15a, which includes the second vertical driving coil CYB, moves in the second direction y when a second vertical electro-magnetic force is applied.

The second vertical electro-magnetic force occurs on the basis of the current that flows through the second vertical driving coil CYB and the magnetic field of the second vertical driving and position-detecting magnet MYB.

The first vertical hall sensor SYA is a magneto-electric converting element (a magnetic field change-detection element) utilizing the Hall effect, and is used for detecting the position of the movable unit 15a in the second direction y by detecting a change in the magnetic-flux density from the first vertical driving and position-detecting magnet MYA, corresponding to a position change of the movable unit 15a in the second direction y.

The second vertical hall sensor SYB is a magneto-electric converting element (a magnetic field change-detection element) utilizing the Hall effect, and is used for detecting the position of the movable unit 15a in the second direction y by detecting a change in the magnetic-flux density from the second vertical driving and position-detecting magnet MYB, corresponding to a position change of the movable unit 15a in the second direction y.

The horizontal hall sensor SX is a magneto-electric converting element (a magnetic field change-detection element) utilizing the Hall effect, and is used for detecting the position of the movable unit 15a in the first direction x by detecting a change in the magnetic-flux density from the first horizontal driving and position-detecting magnet MXA, corresponding to a position change of the movable unit 15a in the first direction x.

The first vertical hall sensor SYA is arranged inside the first vertical driving coil CYA, the second vertical hall sensor SYB is arranged inside the second vertical driving coil CYB, and the horizontal hall sensor SX is arranged inside the first horizontal driving coil CXA. The first and second vertical hall sensors SYA and SYB are arranged so their separation is as large as possible.

The first horizontal driving and position-detecting yoke YXA prevents the magnetic field of the first horizontal driving and position-detecting magnet MXA from diffusing, and increases the magnetic-flux density between the first horizontal driving coil CXA and horizontal hall sensor SX, and the first horizontal driving and position-detecting magnet MXA.

The second horizontal driving and position-detecting yoke YXB prevents the magnetic field of the second horizontal driving and position-detecting magnet MXB from diffusing, and increases the magnetic-flux density between the second horizontal driving coil CXB and the second horizontal driving and position-detecting magnet MXB.

The vertical driving and position-detecting yoke YY prevents the magnetic field of the first vertical driving and position-detecting magnet MYA from diffusing, prevents the magnetic field of the second vertical driving and position-detecting magnet MYB from diffusing, increases the magnetic-flux density between the first vertical driving coil CYA and the first vertical hall sensor SYA, and the first vertical driving and position-detecting magnet MYA, and increases the magnetic-flux density between the second vertical driving coil CYB and second vertical hall sensor SYB, and the second vertical driving and position-detecting magnet MYB.

In the embodiment, the movable unit 15a can be movably and rotatably supported in the x-y plane through the elastic transformation of the frame 18, without a guide mechanism or a mechanism that supports the movable unit 15a by using a ball. Therefore, because it is not necessary to consider a gap and wear based on the clearance of the guide mechanism, a highly accurate and highly stable anti-shake operation can be performed.

Further, the construction can be simplified compared to when a plurality of elastic members are used for movably supporting the movable unit 15a, and united molding or insert molding can be used, so the cost of production can be reduced.

In the embodiment, the elastic transformation of the frame 18 is used to move and rotate the movable unit 15a. However, it is not necessary to consider the elastic force of the frame 18 for the movement control of the movable unit 15a, because the movement control method (the PID calculation of the controller 13) is a feedback control method that calculates the movement quantity (the driving force) required to move the movable unit 15a to the next position on the basis of information regarding its present position; so it is not necessary to perform a complex calculation considering the elastic force.

In the embodiment, it is explained that the hall sensor is used for position detecting as the magnetic field change-detection element, however, a different detection element may deliberately be used for position detection. Specifically, the detection element may be an MI (Magnetic Impedance) sensor, in other words a high-frequency carrier-type magnetic field sensor, or a magnetic resonance-type magnetic field detection element, or an MR (Magneto-Resistance effect) element. When one of either the MI sensor, the magnetic resonance-type magnetic field detection element, or the MR element is used, the information regarding the position of the movable unit can be obtained by detecting the magnetic field change, similarly to the used the hall sensor.

Furthermore, it is explained that the movement of the movable unit 15a is performed on the basis of electro-magnetic force, from the magnet and the coil acting as an actuator. However, the movement of the movable unit 15a may be performed by a different actuator.

Furthermore, it is explained that the frame 18 is used as the supporting mechanism that movably and rotatably supports the movable unit 15a. However, the supporting mechanism may be another mechanism such as a guide mechanism or a mechanism that supports the movable unit 15a by using a ball.

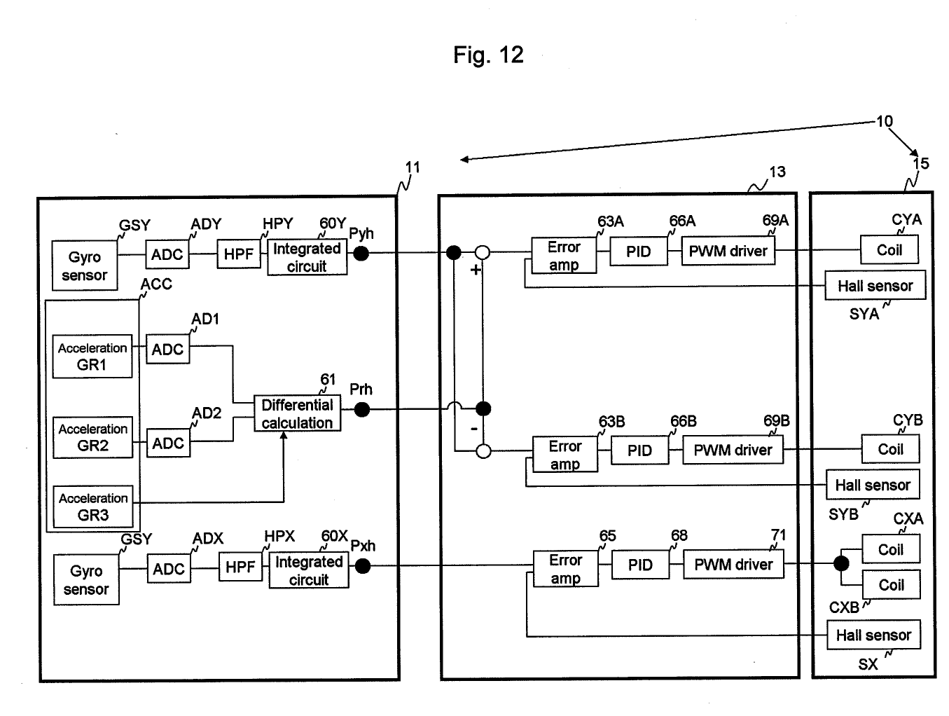

Furthermore, it is explained that the sum of the absolute value of the first gravity acceleration GR1 and the absolute value of the second gravity acceleration GR2, given by |GR1|+|GR2|, is calculated in order to determine whether the angle at which the optical axis O of the photographing apparatus 1 crosses the horizontal surface is close to 90 degrees, in other words, whether the front surface of the photographing apparatus 1 faces largely upward or downward. However, this determination may be performed by other means. For example, an acceleration sensor that detects a third gravity acceleration GR3 in the direction of a third detection axis parallel to the third direction z, may also be used as the acceleration sensor ACC (see FIG. 12). In this case, when the absolute value of the third gravity acceleration GR3 is greater than a third value, it is determined that the optical axis O of the photographing apparatus 1 crosses the horizontal surface at close to 90 degrees; in other words, that the front surface of the photographing apparatus 1 faces largely upward or downward.

Furthermore, it is explained that the roll angular signal Prh that is output as an output value corresponding to the hand-shake extent based on the rotary motion (the roll) of the photographing apparatus 1 about the axis of the third direction z, is used for the anti-shake operation. However, the roll angular signal Prh may be used for an operation other than the anti-shake operation. For example, an inclination angle of the imaging sensor IS, in other words, a first angle at which one pair of sides that compose the outline of the imaging surface of the imaging sensor IS crosses the horizontal surface or a second angle at which the other pair of sides that compose the outline of the imaging surface of the imaging sensor IS crosses the horizontal surface, is specified (calculated) based on the roll angular signal Prh. On the basis of the inclination angle of the imaging sensor IS, the output value from the first vertical hall sensor SYA, and the output value from the second vertical hall sensor SYB, the movable unit 15a is rotated so that one pair of sides or the other pair of sides can be parallel to the horizontal surface. Therefore, one pair of sides that compose the outline of the imaging surface of the imaging sensor IS can be leveled.

Moreover, in the case that the photographing apparatus 1 has a focal-plane shutter or a movable mirror used for a mirror up/down operation, such as in a single reflex-lens camera, the jolt caused by the movement of the front curtain of the focal-plane shutter or by a mirror-up operation of the movable mirror would affect the detection by the acceleration sensor ACC so that the accuracy of the anti-shake operation could deteriorate. In this case, the roll angular signal Prh that is output just before the movement of the front curtain of the focal-plane shutter and the mirror-up operation of the movable mirror (in other words, immediately before the imaging operation), is used for the anti-shake operation. Actually, the value of the roll angular signal Prh stays about the same while the imaging operation is performed after the movement of the front curtain of the focal-plane shutter and the mirror-up operation of the movable mirror so that the hand-shake component due to the roll is hardly compensated for in this period, and the inclination about the optical axis O immediately before the imaging operation is compensated for on the basis of the roll angular signal Prh. In other words, while the optical image is captured by the imaging sensor IS after the movement of the front curtain of the focal-plane shutter and the mirror-up operation of the movable mirror, the anti-shake operation is performed based on the roll angular signal Prh based on the first gravity acceleration GR1 and the second gravity acceleration GR2 that are detected immediately before the movement of the front curtain of the focal-plane shutter and the mirror up operation of the movable mirror, the pitch angular signal Pyh, and the yaw angular signal Pxh.

Furthermore, the movement range of the movable unit 15a for the anti-shake operation corresponding to the pitch and the yaw and the rotation range of the movable unit 15a for the anti-shake operation corresponding to the roll (the compensation of the inclination about the third direction z using the roll angular signal Prh) may be changed according to the focal length of the photographing lens, which is included in lens barrel 2 of the photographing apparatus 1.

Specifically, when the focal length of the photographing lens is short, in other words, when a wide-angle lens is used, the rotation range of the movable unit 15a for the anti-shake operation based on the roll can be widened because the movement range of the movable unit 15a for the anti-shake operation based on the yaw and the pitch can be narrowed. In this case, the upper and lower limits of the roll angular signal Prh that can be output from the differential calculation unit 61 are set to farther apart.

When the focal length of the photographing lens is long, in other words, when a telescopic lens is used, the rotation range of the movable unit 15a for the anti-shake operation based on the roll is narrowed because the movement range of the movable unit 15a for the anti-shake operation based on the yaw and the pitch is widened. In this case, the upper and lower limits of the roll angular signal Prh that can be output from the differential calculation unit 61 are set to close together.

When the roll angular signal Prh is greater than the upper limited value, the differential calculation unit 61 outputs the upper limited value as the roll angular signal Prh. When the roll angular signal Prh is smaller than the lower limited value, the differential calculation unit 61 outputs the lower limited value as the roll angular signal Prh.

Furthermore, it is explained that the acceleration sensor has two or three detection axes. However, two or three acceleration sensors that respectively have one detection axis may be used.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2006-336547 (filed on Dec. 14, 2006) which is expressly incorporated herein by reference, in its entirety.

1. An anti-shake apparatus for image stabilization of a photographing apparatus, comprising:
an imaging sensor that has an imaging surface on which an optical image through a photographing optical system of said photographing apparatus is captured;
an acceleration sensor that detects a first gravitational acceleration component in a direction of a first detection axis and a second gravitational acceleration component in a direction of a second detection axis, said first detection axis and said second detection axis being perpendicular to an optical axis of said photographing optical system; and
an inclination degree output unit that outputs information regarding an inclination angle caused by a roll of said photographing apparatus about said optical axis, based on said first gravitational acceleration component and said second gravitational acceleration component.

2. The anti-shake apparatus according to claim 1, further comprising:
a movable unit that has said imaging sensor; and
a controller that controls a movement of said movable unit on a plane perpendicular to said optical axis, in order to level one of sides that composes an outline of said imaging surface, based on said inclination angle.

3. The anti-shake apparatus according to claim 2, further comprising a pair of position detection sensors that are used for detecting a position of said movable unit in a direction perpendicular to said optical axis;
wherein said controller controls said movement of said movable unit in order to level one of sides that composes said outline of said imaging surface, based on said inclination angle and outputs from said position detection sensors.

4. The anti-shake apparatus according to claim 1, wherein said first detection axis is perpendicular to said second detection axis;
said first and second detection axes cross a direction of gravitational force at an angle of 45 degrees, under the condition in which the photographing apparatus is held level.

5. The anti-shake apparatus according to claim 4, wherein said inclination angle is based on a differential between an absolute value of a first acceleration value obtained from said first gravitational acceleration component and an absolute value of a second acceleration value obtained from said second gravitational acceleration component.

6. The anti-shake apparatus according to claim 4, further comprising:
a pitch gyro sensor;
a yaw gyro sensor;
a movable unit that has said imaging sensor; and
a controller that controls a movement of said movable unit on a plane perpendicular to said optical axis, based on an output from said pitch gyro sensor in response to a first hand-shake extent due to a pitch, an output from said yaw gyro sensor in response to a second hand-shake extent due to a yaw, and said inclination angle, in order to perform an anti-shake operation;
wherein said controller controls said movement of said movable unit based on said first hand-shake extent and said second hand-shake extent without considering said inclination angle, in order to perform said anti-shake operation, when an absolute value of a differential between an absolute value of a first acceleration value obtained from said first gravitational acceleration component and an absolute value of a second acceleration value obtained from said second gravitational acceleration component is greater than a first value.

7. The anti-shake apparatus according to claim 1, further comprising:
a pitch gyro sensor;
a yaw gyro sensor;
a movable unit that has said imaging sensor; and
a controller that controls a movement of said movable unit on a plane perpendicular to said optical axis, based on an output from said pitch gyro sensor in response to a first hand-shake extent due to a pitch, an output from said yaw gyro sensor in response to a second hand-shake extent due to a yaw, and said inclination angle, in order to perform an anti-shake operation.

8. The anti-shake apparatus according to claim 7, wherein said controller controls said movement of said movable unit based on said first hand-shake extent and said second hand-shake extent without considering said inclination angle, in order to perform said anti-shake operation, when a sum of said absolute value of a first acceleration value obtained from said first gravitational acceleration component and an absolute value of a second acceleration value regarding said second gravitational acceleration component is smaller than a second value.

9. The anti-shake apparatus according to claim 7, wherein said acceleration sensor further detects a third gravitational acceleration component in a direction of a third detection axis that is perpendicular to said optical axis; and
said controller controls said movement of said movable unit based on said first hand-shake extent and said second hand-shake extent without considering said inclination angle, in order to perform said anti-shake operation, when said third gravitational acceleration component is greater than a third value.

10. The anti-shake apparatus according to claim 7, further comprising at least one of a focal-plane shutter and a movable mirror;
wherein a controller that controls a movement of said movable unit for said anti-shake operation, based on said inclination angle based on said first and second gravitational acceleration components that are detected immediately before a movement of said focal-plane shutter and said movable mirror, said first hand-shake extent, and said second hand-shake extent, while said optical image is captured by said imaging sensor after said movement of said focal-plane shutter and said movable mirror.

11. The anti-shake apparatus according to claim 7, wherein a movement range of said movable unit for said anti-shake operation corresponding to said pitch and said yaw and a rotation range of said movable unit for said anti-shake operation corresponding to said roll is changed according to a focal length of said photographing optical system.

12. The anti-shake apparatus according to claim 1, wherein said acceleration sensor has two or three detection axes.

13. The anti-shake apparatus according to claim 1, wherein two or three acceleration sensors that respectively have one detection axis are used as said acceleration sensor.
